(19) United States
(12) Patent Application Publication
(10) Pub. No.: US 2010/0270171 A1
(43) Pub. Date: Oct. 28, 2010

(54) A System And A Method For Reducing The Amount of Liquid In A Biological Mass

(76) Inventor: Per Reider Orke, Hafrsfjord (NO)

Correspondence Address: GABLE & GOTWALS, 100 WEST FIFTH STREET, 10TH FLOOR, TULSA, OK, 74103, US

(21) Appl. No.: 12/745,872

(22) PCT Filed: Dec. 3, 2008
(86) PCT No.: PCT/NO2008/000428

§ 371 Date: Jul. 8, 2010

(30) Foreign Application Priority Data
Dec. 6, 2007 (NO) 20076278

(51) Int. Cl. C02F 1/00; C02F 1/04; C02F 1/20; C02F 3/00; C02F 1/461

(52) U.S. Cl. 205/742; 210/195.1; 210/170.01; 202/232; 210/188; 210/609; 203/10; 210/603; 204/242

(57) ABSTRACT

The present invention is directed toward a method and a system for reducing the amount of fluid in a biological mass comprising solids and fluid in the form of liquid and gas. The system includes a temporary storage container for receiving and temporary storing a biological mass, at least one separator arranged to receive the biological mass from the temporary storage container and separate at least a portion of the fluid of the mass from the solids of the mass, a solids container for receiving the solids fraction separated from the biological mass, and a liquid-purifying device arranged to purify the liquid which is separated from the mass by means of the separator. The system is substantially fluidtight towards the surroundings and the separator includes a screen cloth and a device for inducing a fluid flow. The fluid flow is arranged to carry a portion of the liquid out of the mass and through the screen cloth, the essential part of the fluid flow has been recirculated in the system (1).

### CROSS REFERENCE TO RELATED APPLICATIONS

This application is the US National Phase of PCT Application No. PCT/NO2008/000428 filed 3 Dec. 2008 which claims priority to Norwegian Patent Application No. 20076278 filed 6 Dec. 2007 which is incorporated herein by reference.

Publicly available Norwegian Patent No. 323519 entitled “Apparatus For Sieving And Fluid Separation And A Method of Using Same” is incorporated herein by reference.

### STATEMENT REGARDING FEDERALLY SPONSORED RESEARCH

Not applicable

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

The present invention relates to a system and a method for reducing the amount of liquid in a mass. More particularly, it relates to a system and a method for reducing the amount of liquid in a biological mass comprising solids and fluid, the system including a separator arranged to separate at least a portion of the fluid of the mass from the solids of the mass.

In this document the term biological mass includes residual products arising in connection with the production of articles of food or other biological products. Examples of such residual products are manure, slaughterhouse waste and vegetable waste.

In what follows, especially the treatment of manure will be discussed, even though the invention also includes the treatment of other biological mass such as from fish or animal slaughterhouses or vegetable mass from industrial production in which there is a need to separate the mass into a dry solids fraction and one or more fluid fractions.

There are an increasing wish and a need to be able to utilize the energy liberated from biological mass as this goes through a fermentation process. For this, so-called biogas plants are used.

Such biogas plants require relatively large amounts of biological mass, referred to in what follows also as biological waste, for them to be operated economically. In addition, in many countries, the electrical distribution network is not prepared for a variety of power generators out on the net. For these reasons, among other things, trials have been started with organized collection of manure from farms which is delivered to regional biogas plants. Such biogas plants produce electrical energy from gases, methane among others, which are liberated during anaerobic fermentation of the waste. If methane is not combusted, it will be released into the atmosphere. Methane is a so-called greenhouse gas which is considerably more harmful to the environment than carbon dioxide. Thus, it is an advantage also in this environmental aspect to convert methane into carbon dioxide through combustion.

The residual product from the fermentation process is well suited as soil-improving means.

The residual product from the fermentation process may alternatively be used as fuel in, for example, a power plant based on combustion. The fact is that the residual product from manure, for example, contains essentially biological, combustible components of a not insignificant fuel value. Trials have proved that dried farmyard manure may be given a form which makes it easy to handle and well usable in combustion plants, for example through pelleting.

A person skilled in the art will be aware that it is the phosphorous content that puts the limits on the use of manure as a soil-improving means, and this, in turn, leads to the public authorities placing restrictions on spreading area. The lack of spreading area is a limiting factor in the livestock production.

Out of the fact that phosphorous occurs in the solid manure fraction, the separation and use of the solid fraction may lead to the livestock production getting easier terms as far as spreading area is concerned. Therefore, the collection of manure also solves the challenge that some farms have with the spreading area.

An advantage of using a dry manure fraction for fuel as mentioned above is that large amounts of phosphorous are removed from use in agriculture.

Manure has a dry solids content ranging from approximately 3% for so-called liquid manure and up to approximately 33% for solid hen manure. Manure from pigs and cattle has a dry solids content in the order of 4-20%.

From the above, it will be understood that a substantial amount of liquid is transported from the individual farms to biogas plants. This therefore represents a logistic, economic and environmental drawback.

A corresponding set of problems is relevant also for biological waste from, for example, slaughterhouses or other types of production units which create biological waste.

Therefore, a need exists to be able to reduce the liquid content of the biological waste before it is transported from a farm or a slaughterhouse to a biogas plant.

From the publication FR 2781689 is known separating equipment which can carry out a first separation of solid and fluid fractions, that is provide for a substantial part of the unbound amount of liquid to be separated from the solid material.

FR 2781689 discloses a separator comprising two troughs of a partial-cylinder shape, in which scrapers arranged on a rotating shaft are arranged to be moved along a grate which forms the bottom of the troughs. A feeding basin, which is arranged to contain a fluid material which is to undergo separation, is arranged at one edge of the first trough, at which the fluid material is fed into the first trough. An essential element of FR 2781689 is the movable pressure rollers which are arranged on the second rotating shaft in the second trough and which are arranged to press the liquid fraction out of the solid fraction of the material to be separated. The prior art according to FR 2781689 requires a large building height if the separator is to be able to exhibit a sufficiently large capacity, as the capacity is closely connected to the available grate area.

Because of the risk of polluting ground water and river systems, there are in several countries, in addition to restrictions with respect to spreading area, restrictions with respect to the conditions under which manure may be spread onto fields. Among other things, dated periods have been introduced, during which the spreading of manure is prohibited. The periods may be based on, for example, the growing season of plants and climatic empiric data as plants do not absorb and thereby do not need to have nitrogen supplied outside the growing season, and the fact that manure which is spread on frozen or liquid-saturated ground may be carried to river systems and the sea, where over fertilization could represent a serious environmental problem.

In addition to the above-mentioned need to reduce the liquid content of the biological waste before it is transported from a farm or slaughterhouse or other production producing biological waste to a biogas plant, there is therefore also a need to purify the liquid which is separated from the biological waste, so that the liquid may be carried into a sewerage system, for example. Such a sewerage system is preferably a surface water system, but may be in some cases also a so-called grey water or a so-called black water or sewage system.

The above-mentioned prior art does not suggest such purification of the separated liquid.

The invention has for its object to remedy or reduce at least one of the drawbacks of the prior art.

The object is achieved through the features which are specified in the description below and in the claims that follow.

### BRIEF SUMMARY OF THE INVENTION

In a first aspect of the invention, a system is provided for reducing the amount of liquid in a biological mass comprising solids and fluid, the system including at least one separator arranged to separate at least a portion of the fluid of the mass from the solids of the mass, the system further including a liquid-purifying device.

In its simplest form, the liquid-purifying device may be constituted by, for example, a filter for reducing the amount of fines dispersed in the liquid. However, after such purification, the liquid will normally not be admissible for draining into a surface water system or a grey water system.

In one embodiment, the purifying device includes a purifying plant based on an electrolysis process, in which the liquid is carried through one or more electrolysis vessels. In a specific embodiment the electrolysis plant is formed by two containers, the electrodes of one of the containers being made of an aluminium material, whereas the electrodes in the second container are made of iron. The electrodes could, however, be made of any other suitable material.

In one embodiment the purifying device is based on a distillation process.

In one embodiment the purifying device comprises a biological purifying plant in the form of a so-called wetpark or constructed wetland of a kind known per se.

It is an advantage if a liquid container is placed between the separator and the liquid-purifying device, so that a buffer is provided between the separator and the liquid-purifying device. Such a buffer is particularly relevant when the purifying device is constituted by an electrolysis plant or by a plant based on a distillation process.

To be able to collect the solids fraction of the mass, which is separated in the separator, it is an advantage if the system includes a container for receiving solids.

In a preferred embodiment, the system includes at least one temporary storage container for biological mass, placed upstream of at least one of the at least one separator. The temporary storage container serves both to supply the separator with a continuous flow of mass and to start the fermentation process.

It is an advantage if the at least one temporary storage container is arranged to be brought into fluid communication with at least one gas container arranged for the temporary storage of gas which has been liberated from the biological mass while this is in the at least one temporary storage container. In one embodiment the gas container is formed by an inflatable body which fills as gas is being formed.

In cases in which the biological mass is constituted by an inhomogeneous mass, as will be the case with slaughterhouse waste, it is an advantage if a grinding device is placed upstream of the at least one of the at least one separator. In one embodiment the grinding device is placed upstream of the temporary storage container.

It may be an advantage if parts of the system are placed on a means of transport. In particular, it is an advantage if at least one of the at least one separator is placed on a means of transport. The means of transport may be a lorry, for example. This will lead to, among other things, the need for a number of separators being smaller and thereby reduced investments. In addition, space is saved at the supplier of the mass and a generally better utilization of resources is achieved.

A separator which has turned out to be surprisingly effective is a separator constituted by the kind shown in the Norwegian Patent Document No 323519 which is hereby incorporated by reference in the present document. In said patent document is disclosed an apparatus in which the material to be separated is placed on an upper side of at least one screen element which includes an endless screen cloth arranged to be moved around at least two spaced-apart deflection rollers, the apparatus including at least one suction nozzle which has been moved up towards an underside of the endless screen cloth to induce a fluid flow through at least a portion of the material which is on the endless screen cloth, the suction nozzle being connected to a fluidtight container which is evacuated by the use of at least one vacuum pump, the gas phase of the fluid being arranged to be separated from the liquid phase of the fluid in the container, and the gas phase of the fluid and the liquid phase of the fluid being evacuated each separately out of said container.

In a preferred embodiment the system is substantially fluidtight towards the surroundings.

In a second aspect of the invention is provided a method of reducing the amount of liquid in biological waste which comprises solids and fluid, in which the biological waste is carried through at least one separator arranged to separate at least a portion of the fluid of the waste from the solids of the waste, the method including the steps of: purifying the liquid in a liquid-purifying device; and draining the purified liquid.

It is an advantage if the liquid which is separated from the biological mass is temporarily stored in a liquid container before the liquid is carried to the liquid-purifying device.

The purified liquid may be drained into a sewerage system or be deposited or stored temporarily for reuse, for example for irrigation purposes.

It is an advantage if the solids which are separated from the biological waste are carried to further processing.

### BRIEF DESCRIPTION OF THE DRAWINGS

In what follows is described an example of a preferred embodiment which is visualized in the accompanying drawings, in which:

FIG. 1 shows a principle drawing of a plant for the collection of manure, the plant including a temporary storage container and a separator for separating the manure into a solids fraction and fluid fractions;

FIG. 2 shows the same as FIG. 1, but the plant includes two separators of different types;

FIG. 3 shows a principle drawing of a plant for collecting manure, in which parts of the plant are placed on a vehicle.

### DETAILED DESCRIPTION OF THE INVENTION

In the figures, the reference numeral 1 indicates a system for purifying biological waste in accordance with the present invention, the system including a separator 3 arranged to separate the dry solids fraction of the waste from the liquid fraction of the waste.

In the figures are shown some pumps and valves which are neither indicated by reference numerals nor described in further detail. However, a person skilled in the art will understand the need for the valves and pumps. It will also be understood that it may be necessary to have more valves and pumps and other processing equipment than that shown in the principle drawings.

It will be understood that the figures only show principle drawings which are not reproduced to scale and that mutual size relationships between individual components have not necessarily been reproduced correctly.

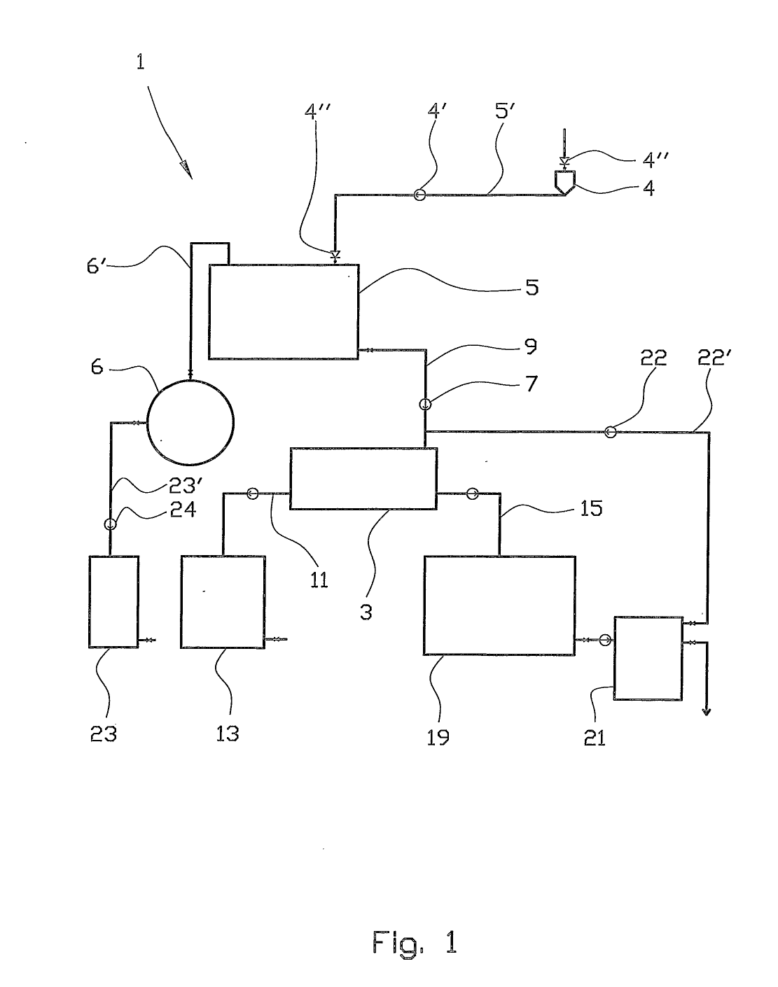

In FIG. 1 waste is supplied to a temporary storage container 5 from one or more smaller receiving tanks 4 (only one shown). The receiving unit 4 may be, for example, a so-called day tank for manure. In the embodiment shown, the receiving tank 4 is provided with a funnel-shaped bottom portion. The manure from the receiving tank 4 is pumped by means of, for example, a lobe pump 4′ through a line 5′ into the temporary storage container 5.

To prevent gas from leaking from the receiving tank 4 into a cow house, for example, the receiving tank 4 is provided with a check valve 4″. A check valve 4″ is also shown to be placed at the inlet portion of the temporary storage container 5.

The separator 3 is supplied with waste from the temporary storage container 5 by means of a pumping device 7 connected to a line 9.

A separator 3 of the kind described in the Norwegian Patent No 323519 and sold under the trade name MUDCUBE® has surprisingly turned out to be highly effective for separating the liquid fraction of the waste from the solids fraction of the waste. MUDCUBE® was developed for use in the petroleum production industry for separating drilling fluid from cuttings.

By a solids fraction and a liquid fraction are meant a fraction containing predominantly solid particles and a fraction containing predominantly liquid.

The solids fraction which has been separated from the waste in the separator 3 is carried via a solids line 11 into a solids container 13. Correspondingly, the liquid fraction which has been separated from the waste in the separator 3 is carried via a liquid line 15 into a liquid container 19.

The solids container 13 containing waste, or just the waste itself, may then be transported to, for example, a biogas plant (not shown), where the solids go through a fermentation process whereby there are formed natural gas and a residual product which may be a well suited soil-improving means, or the residual product may be well suited for use in a combustion plant as earlier mentioned.

The liquid which is in the liquid container 19 contains large amounts of nitrogen, in the form of ammonia for example. The liquid may be a resource when it is allowed to be used as growth-enhancing means in agriculture, for example. However, as earlier mentioned, in periods there may be a ban on the spreading of manure liquid in agriculture.

To be able to deposit or drain the liquid into, for example, a surface water system or a grey water system, there is therefore a need to purify the liquid, so that the contents of, for example, nutrients and possibly heavy metals, are reduced to a predetermined level. The liquid container 19 is therefore connected to a suitable liquid-purifying device 21. A person skilled in the art will understand that the extent of purification required depends on whether the liquid is to be deposited/drained into a surface water, a grey water or a black water system, possibly be used as fertilizing water.

In one embodiment, the liquid-purifying device 21 is based on an electrolysis process, in which the liquid in the liquid container 19 is passed through at least one electrolysis vessel. In one embodiment (not specifically shown), the liquid is passed through a first electrolysis container in which the electrodes are constituted by aluminium and through a second electrolysis container in which the electrodes are constituted by iron. It will be understood that electrodes of other types of material may also be used.

In an alternative embodiment the liquid-purifying device 21 is constituted by a purification system which is based on a distillation process. Relevant distillation processes are so-called MED (Multiple Effect Distillation), so-called MSF (Multiple Stage Flash) or so-called MVC (Mechanical Vapor Compression) which are all well known to a person skilled in the art. There are commercially available a great number of distilling apparatuses based on the distillation processes mentioned. Because of that, a further explanation of said distillation processes will not be given in this document.

A combination of an electrolysis process and a distillation process may also be relevant.

From the purifying device 21 the purified liquid is carried to, for example, a sewerage system or a storing device to be used later for, for example, irrigation purposes.

Residual products from the purifying device 21 may be taken back to the separator 3 by means of a pump 22 connected to a return line 22′. Alternatively, the residual product may be collected and carried out of the system 1 for further processing or purification. In a further alternative (not shown), the residual product may be carried into the solids tank 13.

The temporary storage container 5 is in fluid communication with a gas container 6 via a gas line 6′. The gas container 6 is arranged to receive, for example by means of a pump not shown, at least a portion of the gas which develops in the temporary storage container 5 in consequence of the biological waste fermentation.

In order to, among other things, prevent gases from leaking out of the system 1 shown in the FIGS. 1-3, the system is substantially fluidtight towards the surroundings. By this is meant that the waste is carried in a pipe system 5′, 6′, 9, 11, 15, 23′ from the receiving tank 4, via the collecting container 5 and gas container 6 until the solids are in the solids container 13, which is substantially fluidtight, and the liquid in the liquid container 19 has gone through a sufficient purification to such an extent that it may be deposited, for example drained into a sewerage system.

It should be noted that when the separator 3 is constituted by an apparatus according to Norwegian Patent No 323519, the air flow through the screening element of the apparatus is provided by means of circulation in a closed system instead of air merely being carried through the separator 3 and out into the open air outside the system 1.

In one embodiment (not shown) the separator 3 is arranged to be brought into fluid communication with the gas container 6 by means of a pipeline.

The gas which is forming in the temporary storage container 5 and is being stored temporarily in the gas container 6 is arranged to be carried into a transport container 23, for example by means of a pumping device 24 connected to a line 23′.

The transport container 23 is arranged to be carried to a place of use, such as a biogas plant or as energy for means of transport utilizing natural gas as fuel.

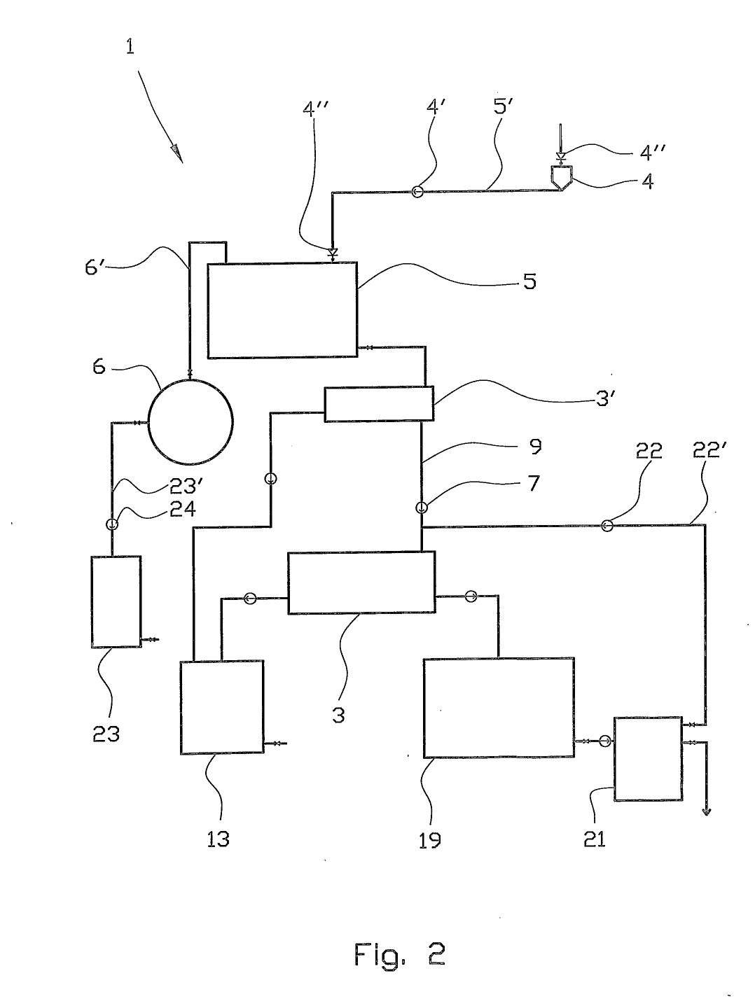

FIG. 2 shows the system of FIG. 1 but where a further separator, known per se, in the form of a cylinder press 3′ is placed between the temporary storage container 5 and the separator 3.

In FIG. 2, manure is carried from the temporary storage container 5 into the cylinder press 3′ in which a substantial amount of the liquid of the manure is separated from the solids part. Experience goes to show that the solids fraction coming out of the cylinder press 3′ is suitable for being carried directly into the solids container 13. The fluid fraction coming out of the cylinder press 3′ is carried into the separator 3 for a solids fraction therein to be separated from the liquid fraction. From the separator 3, the liquid and the solids are carried into respectively the liquid container 19 and the solids container 13, as explained earlier.

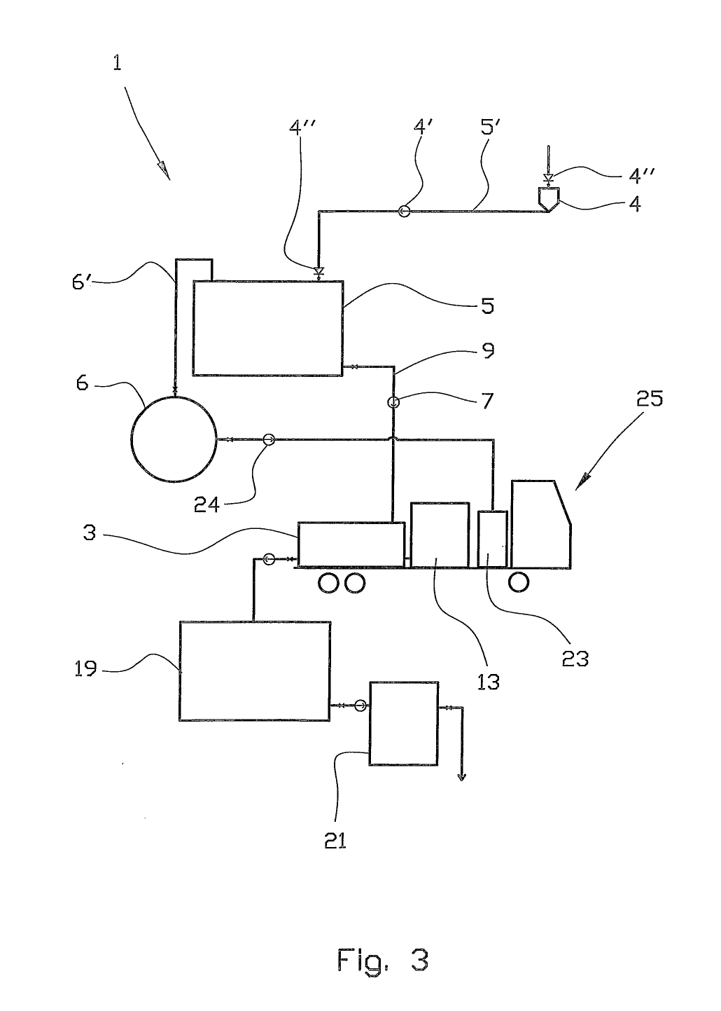

FIG. 3 shows in principle the same as FIG. 1, but parts of the system 1 are placed on the vehicle 25.

On the platform of the vehicle 25 there are a separator 3, a solids container 13 and a transport container 23 for gas. In the example shown, a liquid container 19 and associated liquid-purifying device 21 are stationarily placed in the vicinity of the temporary storage container 5. This is because the process of purifying the liquid might need some more time than what it takes to separate the solids from the liquid. Unnecessary keeping of the vehicle 25 is thereby prevented. In addition, after having been purified, the liquid is to be drained into a surface water system, for example.

When the temporary storage container 5, which may be a so-called manure basin, contains a predetermined amount of manure, the manure is pumped in through the inlet portion of the separator 3. In the separator 3 the solids fraction is separated from the liquid fraction. Said solids fraction and liquid fraction are carried, each separately, out of the separator 3, for example by means of pumping devices (only one shown) into the solids container 13, respectively the liquid container 19. The liquid container 19 is connected to a liquid-purifying device 21 of the kind referred to above, so that the liquid separated from the waste may go through a desired degree of purifying before the earlier-mentioned depositing/draining takes place.

Even though it is not shown in FIG. 3, a return line from the liquid-purifying device 21 may be connected to the separator 3, for example as shown in FIGS. 1 and 2.

The transport container 23, which is on the platform of the vehicle as well, is arranged to receive gas from the gas container 6.

The gas which is in the transport container 23 could also be used as fuel for the vehicle 25.

It will be understood that the cylinder press 3′ shown in principle in FIG. 2, or other suitable separating devices of a kind known per se, could be used independently of whether parts of the system 1 are placed on the vehicle 25 as shown in FIG. 3, or whether the system is stationary as shown in FIGS. 1 and 2.

Thus, the present invention exhibits great advantages in relation to the prior art, as biological mass may be separated in a simple manner into a solids fraction and a gas fraction, which both represent considerable resources, in addition to the liquid fraction being purified to such an extent that it may be deposited at a desired place, for example be drained into a sewerage system. In addition, the problems of spreading area in agriculture and uncontrolled emission of methane gas into the atmosphere are solved.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

1-11. (canceled)

12. A method of collecting biological mass at a producer, wherein fractions of the biological mass are to be utilized in a biogas plant, and wherein the biological mass at the producer includes a solid fraction, a gas fraction and a liquid fraction comprises the steps of:
driving biological mass from a source to a temporary storage container in a fluid-tight pipe system;
letting the gas developing in the temporary storage container be carried via a gas line into a gas container;
placing a mobile plant in fluid communication with the temporary storage container and the gas container by means of a fluid-tight pipe system, the mobile plant including:
a separator which is substantially fluidtight towards the surroundings and which is arranged to separate at least a portion of the fluid of the mass from the solids of the mass, the liquid being separated from the mass by means of a fluid flow;
a transport container for solids; and
a transport container for gas,
the transport container for solids being supplied with solids separated in the separator, and the transport container for gas being supplied with gas from the gas container, and liquid separated from the mass in the separator being transferred to a liquid-purifying device placed at the producer;
disconnecting the mobile plant from said temporary storage container, said gas container and said liquid-purifying device and then carrying the solids and gas to a biogas plant for energy utilization; and
letting the purified liquid from the liquid-purifying device be drained for irrigation purposes and/or into a drain system.

13. The method in accordance with claim 12, wherein the method includes temporarily storing the liquid, which is separated from the mass by means of the separator, in a liquid container before the liquid is carried to the liquid-purifying device.

14. The method in accordance with claim 12, wherein the purification of the liquid separated from the mass is based on one or a combination of two or more of an electrolysis process, a distillation process or a wetpark or constructed wetland.

15. The method in accordance with claim 12, wherein the method includes disposing at least one day tank between the source and the temporary storage container.

16. The method in accordance with claim 12, wherein any gas developing in the temporary storage container is prevented from leaking back to the source by means of at least one check valve.

17. The method in accordance with claim 13, wherein the purification of the liquid separated from the mass is based on one or a combination of two or more of an electrolysis process, a distillation process or a wetpark or constructed wetland.
